(19) United States
(12) Patent Application Publication
(10) Pub. No.: US 2023/0359165 A1
(43) Pub. Date: Nov. 9, 2023

(54) Virtual Evaluation System For Evaluating An Industrial Process Designed To Be Implemented In An Industrial Facility And Associated Method

(71) Applicant: TECHNIP FRANCE, NANTERRE CEDEX (FR)

(72) Inventors: Julien Metayer, Courbevoie (FR); Ludwig Gross, PARIS (FR); Fabrice Rey, Courbevoie (FR)

(21) Appl. No.: 18/029,348

(22) PCT Filed: Sep. 29, 2021
(86) PCT No.: PCT/EP2021/076831

§ 371 Date: Mar. 29, 2023

(30) Foreign Application Priority Data
Sep. 29, 2020 (FR) FR2009886

(51) Int. Cl. G05B 19/4069; G05B 19/4063

(52) U.S. Cl. CPC G05B 19/4069; G05B 19/4063; G05B 2219/33301

(57) ABSTRACT

The system comprises a centralization and interface module, capable of interconnecting module for dynamically simulating the process and an immersive simulation module for enabling an operator and/or a robot to perform, in real time in an immersive three-dimensional representation, a virtualized implementation of an industrial process comprising actions performed in the immersive three-dimensional representation. It comprises a module for monitoring the implementation of the process, the module being capable of recording monitoring data including operating parameters of the process and/or real-time actions of the operator and/or the robot, and a rendering module capable of processing the obtained monitoring data and providing a rendering of a virtual implementation of the process, the rendering being designed to control or optimize the industrial process.

### CROSS-REFERENCE TO RELATED APPLICATIONS

This application is a U.S. National Stage filed under 35 U.S.C. §371, based on International PCT Application No. PCT/EP2021/076831, filed on Sep. 29, 2021, which claims priority to French Application FR2009886 filed on Sep. 29, 2020 in the French Patent Office. The entire contents of these applications are incorporated herein by reference in their entirety.

### BACKGROUND OF THE INVENTION

The present invention relates to a system of virtual evaluation of an industrial process intended for being implemented in an industrial facility, the system including:
a module of dynamic stimulation of the process, suitable for dynamically computing operating parameters of the process, based on input parameters;
an immersive simulation module of the facility, the immersive simulation module being apt to generate an immersive three-dimensional representation of the facility comprising a plurality of simulated controls apt to define input parameters for the module for dynamic simulation of the process;
a display and/or control system suitable for being operated by a real operator and/or by a robot, for navigating in the immersive three-dimensional representation, and for actuating the or each simulated control.

The industrial process is e.g. a process for involving fluids, more particularly hydrocarbons, and/or a process for the production and/or treatment of chemical or biological products, the industrial facility being an onshore or an offshore facility.

In a variant, the process is a process for the production of energy, in particular electrical energy, by means of wind turbines, tidal stream generators or thermal or geothermal power plants.

Industrial processes for involving fluids, for the production of chemical or biological products, or even for the production of energy, are generally complex processes requiring the implementation of a large number of actions for ensuring the production ramp-up, the production itself, the shutdown of the facility, the curative or preventive maintenance or the management of breakdowns or emergencies.

Hence, such processes require the development of detailed operating procedures for ensuring a safe and efficient implementation of the process, in order to combine the quality of the products obtained, productivity, safety and compliance with environmental constraints.

To meet such goals, the industrial process is generally implemented at least in part by operators or by robots who carry out the operations needed on-site.

The operators and the robots are generally in communication with a control room, wherein the implementation of the process is monitored, by following more particularly operating parameters of the process, obtained from sensors present in the facility.

In order to create or to modify an operating procedure of an industrial process, it is known how to plan a list of actions to be carried out on the basis of previous knowledge or experience, then to test the list of actions directly in the facility. The operating procedure is then modified sequentially according to the feedback obtained during the practical implementation.

Testing and optimization of operating procedures can in some cases create problems in the facility, more particularly reductions or interruptions of production, or even incidents or accidents.

Similarly, in order for robots to function properly, it is necessary to train the robots within the facility. However, the above sometimes requires stopping the facility or carrying out limited training, so as not to disturb production too much.

Moreover, it could be desirable for operators to have on-site tools for monitoring operating parameters of the process, which would allow the operators to better understand the situation the operators are facing, without necessarily having to interrogate the control room. Such tools are usually designed outside the facility and are then tested in the facility by operators.

The implementation of such tests is generally tedious, since the implementation disrupts the work of the operators. The implementation leads to failures which can be costly, in particular when a tool is developed as a test and is not accepted in practice by the operators.

In any case, the tests which are done to establish an operating procedure, train a robot and/or test a monitoring tool are limited in the application thereof, because such tests cannot include dangerous operations, which would create safety hazards in the facility.

Furthermore, it is not possible to test an operating procedure, train a robot or determine if a monitoring tool for the process is effective, if the facility is under design or construction.

Virtual facility simulators have been developed to train operators in the implementation of the process. Such simulators generally comprise a representation of the screens visible in the control room, and can be used for following the process under conditions which may differ from the usual conditions for conducting the process.

There are also immersive training simulators which allow an operator to move in a virtual environment reconstructing the facility wherein the actual process is to be performed.

Such simulators operate according to a generally predetermined scenario and can be used only for evaluating whether an operator is able to conduct an already established operating procedure.

One aim of the invention is to provide a system for easily evaluating and optimizing, cost effectively and in a very realistic manner, industrial processes and/or tools for industrial processes which should be implemented in an industrial facility, which are safe for the facility and without affecting production, including before the actual site is available.

### SUMMARY OF THE INVENTION

To this end, the subject matter of the invention is a system of the aforementioned type, characterized by:
a centralization and interface module, suitable for interconnecting the module for the dynamic simulation of the process and the immersive simulation module so as to allow an operator and/or a robot to perform in real time, in the immersive three-dimensional representation, a virtual implementation of the industrial process comprising actions performed in the immersive three-dimensional representation, the actions performed in the immersive three-dimensional representation including the actuation of at least one simulated control, the centralization and interface module being suitable for dynamically receiving, from the module for the dynamic simulation of the process, operating parameters of the industrial process according to the input parameters, resulting from actions performed by the operator and/or the robot in the immersive three-dimensional representation;
a module for monitoring the implementation of the process, suitable for recording monitoring data including operating parameters of the process and/or actions of the operator and/or of the robot as a function of time;
a rendering module, suitable for processing the monitoring data obtained and for providing a rendering of a virtual implementation of the process, intended for the conduct or the optimization of the industrial process.

The system according to the invention can comprise one or a plurality of the following features, taken individually or according to any technically possible combination:
the immersive simulation module is apt to modify the immersive three-dimensional representation according to an action on a simulated control;
the immersive simulation module is apt to compute an effect of an action on a simulated control according to a physical model of impact of the action on the operator, on the robot and/or on the environment around the operator and/or the robot, and to modify the immersive three-dimensional representation and/or the movement of the operator and/or of the robot in the immersive three-dimensional representation, on the basis of the computed effect;
the environment around the operator and/or the robot includes a piece of equipment operated by the simulated control, including a valve;
the immersive simulation module is apt to compute sensor data for monitoring the movement of a robot during a virtual implementation of the process according to a physical model of the movement of the robot in the facility and to send the sensor monitoring data to a control unit for the robot;
the centralization and interface module is suitable for dynamically receiving at least one input parameter resulting from a simulated control performed by the operator and/or the robot in the immersive three-dimensional representation generated by the immersive simulation module, the module for dynamic simulation of the process being apt to load the or each input parameter received into the centralization and interface module, so as to perform a dynamic simulation of the process, and to obtain at least one operating parameter of the process, on the basis of the or each input parameter resulting from a simulated control performed by the operator and/or the robot in the immersive three-dimensional representation;
the centralization and interface module is suitable for dynamically receiving the or each operating parameter of the process resulting from the dynamic simulation of the process, the immersive simulation module being advantageously apt to load the or each operating parameter of the process resulting from the dynamic simulation of the process, in order to modify the immersive three-dimensional representation;
the rendering module is apt to automatically produce a report on virtual implementation of the process, including a time-dependent list of monitoring data collected by the monitoring module;
the monitoring module includes a speech recognition application, the report on a virtual implementation of the process includes a time-dependent text rendering of words pronounced by the operator during a virtual implementation of the process, as obtained using the speech recognition application;
the display and/or control system comprises a set of measurements of positions and orientations of the operator and/or of the robot in the immersive three-dimensional representation, the report on a virtual implementation of the process comprises a list of orientation position data from a viewpoint of the operator and/or of the robot as a function of time in the immersive three-dimensional representation during a virtual implementation of the process the viewpoint of the operator and/or of the robot being obtained from measurements taken by all the measurements of the positions and the orientations of the operator and/or of the robot in the immersive three-dimensional representation;
the report on a virtual implementation of the process includes a list of pictures or videos from a viewpoint of the operator, as a function of time, in the immersive three-dimensional representation during a virtual implementation of the process;
the display and/or control system is suitable for being operated by a robot comprising a control unit containing a list of actions of a real or a virtual process to be carried out, the robot being apt, during the implementing of the real or a virtual process, to stop the actions to be carried out in the presence of conditions temporarily preventing the continuation of the real or a virtual implementation of the process, the robot or a driver of the robot being apt to initiate a virtual implementation of a continuation of the process, on the basis of at least one modified action in the action list, the rendering module being apt to establish, from the monitoring data collected by the monitoring module during a virtual implementation of the continuation of the process, evaluation criteria for an actual or virtual continuation of the process containing at least one modified action;
the immersive simulation module is suitable for representing, in the immersive three-dimensional representation, at least information relating to the process and intended for the operator, coming from the module for dynamic simulation of the process;
the immersive simulation module is suitable for representing, in the immersive three-dimensional representation, a monitoring tool for the process, displaying information on the process, the monitoring tool being more particularly an augmented reality device;
the report on the implementation of the process includes a table listing a list of execution times of actions performed in the immersive three-dimensional representation, a corresponding list of actions performed in the immersive three-dimensional representation, advantageously obtained using the controls applied to the simulated controls, and/or operator statements when the operator implements actions, and/or pictures and/or videos from the viewpoint of the operator or of the robot, a corresponding list of positions and/or orientations of the operator or of the robot, from the viewpoint of the operator or of the robot;
the system includes a control room simulation module, interconnected to the module for dynamic simulation of the process and to the immersive simulation module via the centralization or interface module, so as to enable a control operator to monitor, on at least one process display window, the operating parameters of the process resulting from actions performed in the immersive three-dimensional representation, the monitoring data including control operator statements and/or an identifier of the process display window;
the table of reports on the implementation of the process includes a corresponding list of identifiers of the process display window seen by the control operator.

The invention further relates to a method of virtual execution of an industrial process, the industrial process being intended for being implemented in an industrial facility, the method including the following steps:
provision of a virtual evaluation system as defined hereinabove;
navigation, via the display and/or control system of a real operator and/or of a robot in the immersive three-dimensional representation generated by the immersive simulation module, so as to perform actions in the immersive three-dimensional representation, the actions including the actuation of at least one control defining input parameters for the module for dynamic simulation of the process;
obtaining real-time operating parameters of the process, via the module for dynamic simulation of the process, according to the input parameters resulting from the actions performed by the real operator and/or the robot, received by the centralization and interface module and loaded by the module for dynamic simulation of the process;
recording, by the monitoring module, of monitoring data including operating parameters of the process and/or actions of the operator and/or of the robot as a function of time;
processing, by the rendering module of the monitoring data obtained for providing a rendering of a virtual implementation of the process, intended for the conduct or the optimization of the industrial process.

The method according to the invention can comprise one or a plurality of the following features, taken individually or according to any technically possible combination:
the method comprising the following steps:
   * dynamic reception by the centralization and interface module of at least one input parameter resulting from a simulated control performed by the operator and/or the robot in the immersive three-dimensional representation generated by the immersive simulation module,
   * loading, by means of the module for dynamic simulation of the process, the or each input parameter received in the centralization and interface module for performing a dynamic simulation of the process, and obtaining at least one operating parameter of the process, on the basis of the or each input parameter resulting from a simulated control performed by the operator and/or the robot, in the immersive three-dimensional representation,
   * dynamic reception, by the centralization and interface module, of the or each operating parameter of the process resulting from the dynamic simulation of the process,
   * if appropriate, loading, by means of the immersive simulation module of the or each operating parameter of the process resulting from the dynamic simulation of the process, so as to modify the immersive three-dimensional representation;
the processing, by means of the rendering module including the automatic production of a report on a virtual implementation of the process, including a time-dependent list of monitoring data collected by the monitoring module.
the monitoring module including a speech recognition application producing a word-by-word rendering of words pronounced by the operator during a virtual implementation of the process, the report on a virtual implementation of the process including the word-by-word rendering as a function of time.
the navigation includes the operation of the system of display and/or control by a robot, the robot comprising a control unit containing a list of actions of a real or a virtual process to be performed.
during the implementation of the real or virtual process, the robot stops the actions same has performed in the presence of conditions temporarily preventing the continuation of the real or a virtual implementation of the process, the method comprising the launch, by the robot or by a driver of the robot, of a virtual implementation of a continuation of the process, on the basis of at least one modified action in the action list, the rendering module establishing, from the monitoring data collected by the monitoring module during a virtual implementation of the continuation of the process, evaluation criteria for a real or a virtual continuation of the process, containing at least one modified action.
the immersive simulation module represents, in the immersive three-dimensional representation, a monitoring tool for the process, displaying information on the process to the operator, the monitoring tool being more particularly an augmented reality device.

The invention further relates to the use of an operating procedure prepared from at least one report on a virtual implementation of the process, obtained using an implementation of the virtual execution process as defined hereinabove, for operating a real industrial process in an industrial facility, depending on the procedure.

In a variant, a plurality of reports of virtual implementation of the process are obtained by a plurality of implementations of the virtual execution method as defined hereinabove, under different conditions of execution of the virtual execution method, the procedure being prepared using one of the reports on a virtual implementation of the process.

### BRIEF DESCRIPTION OF THE DRAWINGS

The invention will be better understood upon reading the following description, given only as an example and making reference to the enclosed drawings, wherein :

FIG. 1 is a synoptic diagram representing a virtual evaluation system according to the invention, for evaluating and optimizing an industrial process intended for being implemented in an industrial facility;

FIG. 2 is an immersive three-dimensional representation of the facility wherein the process is implemented, generated by an immersive simulation module;

FIG. 3 is a view of a control interface of the facility generated by a module for dynamic simulation of a virtual evaluation system;

FIG. 4 is a view of a report obtained using the monitoring data measured during a virtual implementation of the industrial process in a virtual evaluation system according to the invention;

FIG. 5 is a view similar to FIG. 1 showing a variant of the system according to the invention;

FIG. 6 is a view illustrating conditions which temporarily or definitively prevent the continuation of the implementation of the process, during a virtual implementation of a process with a robot;

FIG. 7 is a view of an immersive three-dimensional representation of an augmented reality tool for monitoring a process in an industrial facility, evaluated using a virtual evaluation system according to the invention;

FIG. 8 illustrates another example of a report on a virtual implementation of the process obtained using an implementation of the virtual execution method according to the invention, intended for the preparation of a procedure for a real industrial facility;

FIG. 9 is a graph generated in the report on a virtual implementation of the process represented in FIG. 8, the graph illustrating physical parameters simulated by the module for dynamic simulation of the process during the implementation of the virtual execution method according to the invention.

### DETAILED DESCRIPTION

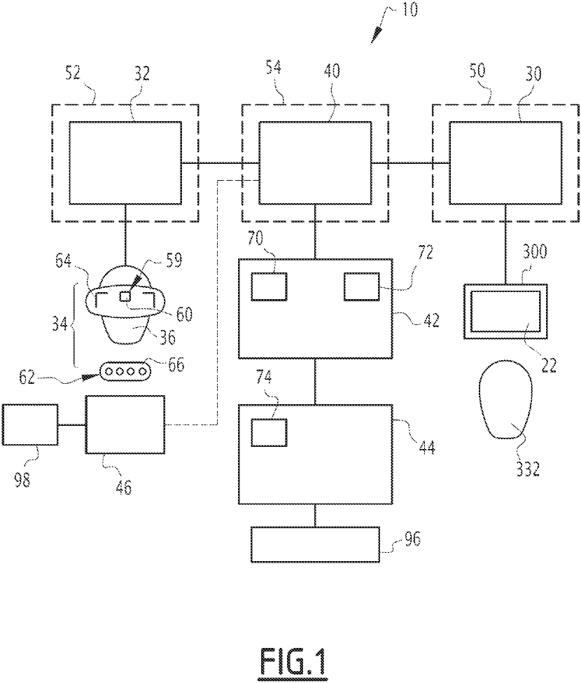

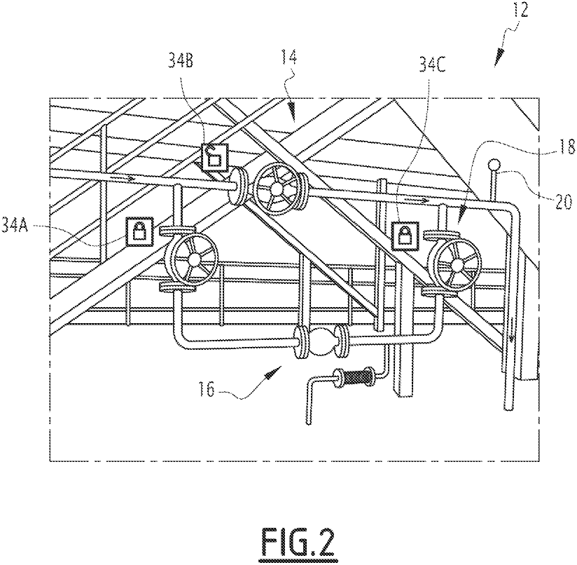

FIG. 1 schematically illustrates a first system 10 for the virtual evaluation of an industrial process. The process is intended to be implemented in an industrial facility, an immersive three-dimensional representation 12 of which can be seen in FIG. 2.

An industrial facility is e.g. a facility involving fluids, a facility for producing energy, or a facility for treating and/or producing chemicals or biological products.

The industrial process is a production process and/or a maintenance process of the facility. The process includes a plurality of actions to be performed, examples of which will be given hereinbelow.

The facility preferentially comprises infrastructures 14 and equipment 16 which are mounted on the infrastructures 14. The facility further comprises controls 18 for the equipment 16 and sensors 20 for measuring parameters of the process.

The infrastructures 14 comprise e.g. trays, stairs, supports, intended for receiving the equipment 16, to support the equipment and to allow operators or robots to move within the facility, aimed at implementing steps of the industrial process.

The equipment 16 include e.g. pipes, pumps, compressors, turbines, valves, tanks, generators, motors, or any other equipment which can be located in an industrial facility.

The equipment items 16 are connected to one another according to a facility diagram, which could include a mechanical diagram, a hydraulic diagram, an electrical diagram, and/or a computer diagram.

The controls 18 are e.g. switches, components for opening or closing valves or pipes, and/or actuators. Such controls can be operated manually by an operator and/or a robot, or can be operated remotely by software switches, from a control screen in a control room.

The sensors 20 are e.g. sensors for measuring temperature, pressure, electrical power, or any other physical quantity likely to be monitored for the implementation of the process.

In the example of the facility shown virtually in FIG. 2, the equipment 16 comprises pipes and valves, the controls 18 comprise wheels for opening or closing the pipes of the valves, and the sensors 20 comprise pressure gages for measuring the pressure in the pipes.

As indicated hereinabove, the implementation of the process can be monitored by operators present in a control room, generally located in the facility, or remote from the facility.

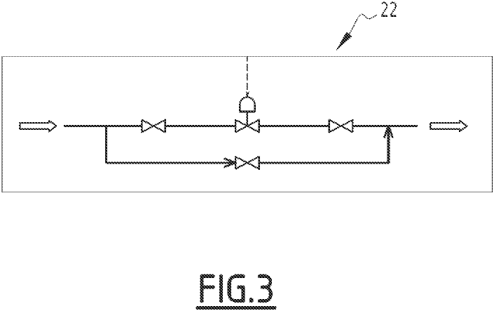

With reference to FIG. 3, the control room generally comprises at least one control interface 22 which presents a diagram of the facility, e.g. a description of the equipment 16, the controls 18, and of the sensors 20. Generally, the actuation statuses of the remote controls, and the data received from the sensors 20 are sent to the control room in order to follow the progress of the process on the control interface 22.

With reference to FIG. 1, a virtual evaluation system 10 comprises at least one computer platform, preferentially a plurality of computer platforms each comprising at least one computer provided with a processor and at least one memory containing software modules suitable for being executed by the processor.

Each memory contains at least one software module intended for executing functions of a virtual evaluation system 10.

In the example shown in FIG. 1, a virtual evaluation system 10 thus includes a module 30 for the dynamic simulation of the process, apt to determine operating parameters of the process, depending on the facility structure and on input parameters resulting from the implementation of the process in the facility.

The virtual evaluation system 10 further comprises an immersive simulation module 32 of the facility, the immersive simulation module 32 being apt to generate an immersive three-dimensional representation 12 of the facility, the immersive three-dimensional representation 12 comprising a plurality of simulated controls 34A, 34B, 34C of the equipment 16 suitable for defining input parameters for the module 30 for dynamic simulation of the process.

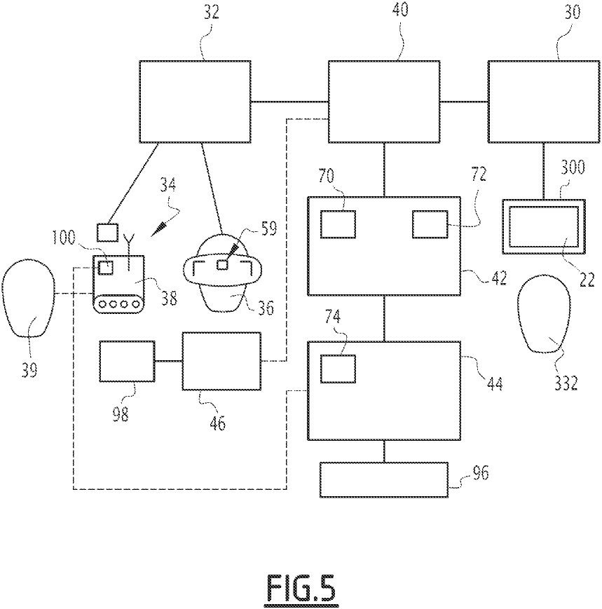

The virtual evaluation system 10 further includes a display and/or control system 34 suitable for being operated by a real operator 36 or by a robot 38 (see FIG. 5) so as to navigate in the immersive three-dimensional representation 12 and to perform the actions corresponding to the implementation of the process, in particular to actuate one or a plurality of simulated controls 34A to 34C. As will be seen below, the immersive simulation module 32 is advantageously apt to adapt the environment underlying the immersive three-dimensional representation 12 as a function of the actions performed by the operator 36 and/or by the robot 38, by following physical models of the effect of the actions on the environment.

According to the invention, the system 10 further includes a centralization and interface module 40, suitable for interconnecting the module 30 for dynamic simulation of the process and the immersive simulation module 32 so as to allow the operator 36 and/or the robot 38 to perform in real time, in the immersive three-dimensional representation 12, a virtual implementation of the industrial process comprising actions performed in the immersive three-dimensional representation 12, the actions performed in the immersive three-dimensional representation 12 including the actuation of at least one simulated control 34A to 34C, the centralization and interface module 40 being suitable for dynamically receiving, from the module 30 for dynamic simulation of the process, operating parameters of the industrial process according to the input parameters, resulting from actions performed by the operator 36 and/or the robot 38 in the immersive three-dimensional representation 12.

The virtual evaluation system 10 further includes a module 42 for monitoring a virtual implementation of the industrial process, apt to record data for monitoring the operating parameters of a virtual process and the actions of the operator 36 and/or of the robot 38 as a function of time.

The virtual evaluation system 10 also comprises a rendering module 44 adapted to process the monitoring data obtained and to provide a rendering of a virtual implementation of the process, intended for conducting or optimizing the industrial process.

Optionally, a virtual evaluation system 10 further includes a module 46 for initializing and/or defining a process scenario, intended for guiding the operator 36 or the robot 48 for implementing the steps of the process.

In the configuration shown in FIG. 1, a virtual evaluation system 10 includes a plurality of computer platforms, with at least one computer platform 50 housing the module 30 for the dynamic simulation of the process, at least one computer platform 52 housing the immersive simulation module 32, and at least one computer platform 54 housing the centralization and interface module 40 and the monitoring 42 and rendering 44 modules. The computer platforms 50, 52, 54 are interconnected by data transmission links, in particular by computer networks.

The module 30 for dynamic simulation of the process is e.g. an operator training simulator (OTS) module. Same comprises a human-machine interface and a dynamic process simulator, which is apt to compute operating parameters of the process as a function of time, on the basis of input parameters of the implementation of the process.

The input parameters are e.g. environmental parameters external to the facility (e.g. temperature, pressure), physical parameters related to the fluids present in the facility (e.g. nature, quantities, relative flow rates, etc.), energy parameters (e.g. heating, cooling, expansion, pressurization) and control state parameters (e.g. valve openings, temperature, pressure, flow settings) of the process.

The operating parameters of the process are parameters calculated using dynamic physical models of the process, e.g. electrical, thermodynamic, physical-chemical models, in application of the principles of process engineering.

The operating parameters of the process are e.g. physical parameters observed in the facility, in particular in the equipment 16, or in the fluids present in the facility such as temperature, pressure, composition, produced or consumed electrical power, flow rate, accumulation of material, especially in the form of a level.

In the example shown in FIG. 3, the human-machine interface includes a control interface 22 identical to the control interface of a control room of the facility, for defining remote action parameters and for displaying the parameters for monitoring the key values of the operation of the industrial process.

As will be seen below, the module 30 for dynamic simulation of the process is also apt to collect, in the centralization and interface module 40, input parameters coming from the immersive simulation module 32. Such input parameters are more particularly simulated control states 34A to 34C actuated in the immersive three-dimensional representation 12 of the facility, generated by the immersive simulation module 32.

Based on the input parameters, the dynamic process simulator is apt to dynamically compute the operating parameters of the process as a function of time, using models defined hereinabove, and apt to supply the dynamics of the operating parameters to the control interface 22 and to the immersive simulation module 32 for a dynamic display of monitoring data of the process.

The dynamic frequency of obtaining monitoring data of the process is e.g. greater than 1 Hz.

The module 30 for dynamic simulation of the process is apt dynamically to send the monitoring data of the process, during a virtual implementation of the process, to the centralization and interface module 40.

Advantageously, the module 30 for dynamic simulation of the process is furthermore suitable for sending the monitoring data of the process, during a virtual implementation of the process, to a simulated control room 300, displaying a representation of the control interface 22, for the attention of a real operator 332 in charge of monitoring the implementation of the process.

The immersive simulation module 32 is e.g. an Immersive Training Simulator (ITS) module.

Same contains a digital model and an engine for generating an immersive and interactive three-dimensional representation 12 of the facility, on the basis the digital mock-up.

The digital mock-up advantageously includes at least one computer file including positioning, shape and operating data of each of the elements of the facility, more particularly of the infrastructures 14, the equipment 16, the controls 18, and of the sensors 20.

Such mock-up is advantageously organized in the form of a tree of digital mock-ups coming from computer-aided design software.

The mock-up further defines the possible positions and states of the simulated controls 34A, 34B, 34C suitable for being controlled by an operator 36 and/or by a robot 38 in the immersive three-dimensional representation 12.

The immersive three-dimensional representation 12 is generated by the generation engine from the digital mock-up, at a position and according to a viewpoint defined by the display and control system 34.

Thereby, an operator 36 or a robot 38 is apt to navigate in the immersive three-dimensional representation 12 by means of the display and/or control system 34, more particularly for moving towards the simulated controls 34A, 34B, 34C and for actuating the controls.

Furthermore, the immersive simulation module 32 is apt to modify the immersive three-dimensional representation 12 according to an action on a simulated control 34A, 34B, 34C.

The modification can be simple, in particular a binary change from a first control value to a second control value.

Advantageously, the immersive simulation module 32 is apt to compute an effect of an action on a simulated control 34A, 34B, 34C, according to a physical model of impact of the action on the operator 36, on the robot 38 or on the environment around the operator 36 and/or the robot 38, and to modify the immersive three-dimensional representation and/or the movement of the operator 36 and/or the robot 38 in the immersive three-dimensional representation 12, on the basis of the computed effect.

The environment around the operator 36 and/or the robot 38 includes an item of equipment 16 actuated by the simulated control 34A, 34B, 34C, in particular a valve.

The physical model is advantageously a model computing an effect of the control on a physical parameter, e.g. the percentage of opening of a valve, as a function of the intensity and/or time of application of the control by the operator 36 or the robot 38.

The physical model can take into account environmental data around the operator 36 and/or the robot 38, e.g. meteorological data, or operating data of the equipment used for the control, e.g. the presence of seizing or rust on a valve.

In addition, the immersive simulation module 32 is apt to modify the positioning, shape and operating data of each of the elements of the facility, depending on the control performed for updating the immersive virtual representation and the movement of the operator 36 and/or the robot 38 therein. E.g., when a control lever of an item of equipment is actuated, the lever is likely to move in the environment around the operator 36 and/or the robot 38, creating an obstacle in the environment.

In case a robot 38 is used, the immersive simulation module 32 is further apt to compute sensor data monitoring the movement of the robot 38 during a virtual implementation of the process as a function of a physical model of the movement of the robot in the facility, and sending the monitoring sensor data to a central control unit for the robot 38.

E.g., the immersive simulation module 32 is apt, at each moment and on the basis of a physical model, to simulate the effective position of the robot 38 in the facility, to determine whether the robot 38 is apt to move to a desired position in the presence of obstacles or slopes defined in the facility or if the robot is locked in position. Same is apt to reproduce the simulation carried out in the form of sensor data of the monitoring of the position, the state (load, blockage, etc.) which are sent to the control center of the robot. Thus, the robot control unit receives from the immersive simulation module 32, the same data which would be emitted by physical sensors of a real robot.

The data generated by the immersive simulation module 32 are e.g. obtained dynamically, at a frequency advantageously greater than 20 Hz.

In the example shown in FIG. 1, the display and/or control system 34 thus includes at least one immersive display device 59 suitable for providing the operator 36 or a driver 39 of the robot 38, with a graphic rendering of the immersive three-dimensional representation 12 at the position and according to the chosen viewpoint.

Same further includes an assembly 60 for measuring positions and orientations of the operator 36 or of the robot 38 in the immersive three-dimensional representation 12 and an assembly 62 for controlling the movement and the simulated controls 34A to 34C in the immersive three-dimensional representation 12.

The display device 59 is suitable for retrieving the immersive three-dimensional representation data 12 of the facility 10 of the immersive simulation module 32, at the position and with the viewpoint defined by the measuring assembly 60 and by the control assembly 62. Same comprises e.g. a helmet and/or virtual reality glasses 64, or a screen.

The measuring assembly 60 is suitable for determining the position and orientation of the head and the limbs of the operator 36 or the position and orientation of the robot 38. Same consists e.g. of position and orientation sensors, e.g. arranged on the helmet 64 or on the robot 38.

The control assembly 62 is suitable for allowing the operator 36 or the robot 38 to modify the position thereof within the immersive three-dimensional representation 12, and also for actuating the simulated controls 34A to 34C within the immersive three-dimensional representation 12.

For an operator 36, the control assembly 62 consists e.g. of a joystick 66 comprising direction control buttons and actuation control buttons.

In a variant, in the case of a robot 38, the displacement assembly 62 is formed by an interface with a central control unit 100 of the robot 38 following a predefined trajectory for the robot 38, or following a control given by a driver 39 of the robot 38.

The measuring assembly 60 and the control assembly 62 are suitable for sending the position and orientation information of the operator 36 or of the robot 38 to the immersive simulation module 32, for generating the immersive three-dimensional representation 12 at the position and according to the viewpoint of the operator 36 or of the robot 38.

The centralization and interface module 40 is connected to the immersive simulation module 32, and to the module 30 for dynamic simulation of the process, for dynamically collecting the position data of the operator 36 or of the robot 38, as well as the controls applied by the operator 36 and/or the robot 38 via the simulated controls 34A to 34C, in the form of input data intended to be read dynamically by the module 30 for dynamic simulation of the process.

Same is also apt to dynamically collect the process parameters resulting from the operations performed by the operator 36 and/or the robot 38 by moving in the immersive three-dimensional representation 12, and by actuating the simulated controls 34A to 34C over time, obtained by the module 30 for dynamic simulation of the process.

E.g., when the operator 36 actuates a simulated control 34A in the immersive three-dimensional representation 12, a virtual immersion module 32 generates input data which is sent to the centralization and interface module 40, and which is read by the module 30 for dynamic simulation of the process.

The input data, e.g. an open or a closed state of a valve, is then taken into account and a dynamic simulation of the process is performed by the dynamic process simulator of the module 30. The physical parameters resulting from the control, e.g. the opening or the closing of the valve, such as flow rate, temperature, or reactions occurring in the process are then simulated over time. The simulation results are collected by the centralization and interface module 40, and are read by a virtual simulation module 42, so as to update the immersive three-dimensional representation 12.

Thus, the centralization and interface module 40 forms a dynamic database which interconnects the simulation modules 30, 32, allowing each simulation module 30, 32 to read, in the database, the data coming from the other simulation module 32, 30, needed for implementing the own dynamic simulation thereof, then for dynamically feeding the database with simulation data obtained in the dynamic simulation thereof.

The above allows the real operator 36 and/or the robot 38 to perform in real time, in the immersive three-dimensional representation 12, a virtual implementation of the industrial process via the display and control system 34, resulting from a co-simulation interconnected by the immersive simulation module 32 and by the module 30 for dynamic simulation of the process.

The database of the centralization and interface module 40 is updated dynamically, in near real time, with the data provided and exchanged between the immersive simulation module 32, the module 30 for dynamic simulation of the process and the monitoring module 42, each at their own frequency of reading and writing. All the data exchanged is available at any moment for the three modules. Each type of data has specific read and/or write rights for each module 30, 32, 42.

The real operator 36 and/or the robot 38 is thus apt to perform all the actions needed for implementing the process, including moving to a given position, actuating a simulated control 34A to 34C, more particularly a switch, a valve, a variable-frequency drive, apt to monitor a measured physical parameter, or yet to access specific equipment information such as equipment specification sheets

The initialization module 46 is suitable for enabling the operator 36 to define, prior to the implementation of the process, a series of actions to be performed in the process. The module includes e.g. a human-machine interface 98 apt to establish the list of actions to be performed. If appropriate, the initialization module 46 is apt to communicate with the centralization and interface module 40 in order to allow the module 30 for dynamic simulation of the process and/or a virtual immersion module 32 to carry out work prior to a virtual implementation of the process, e.g. prior simulations of certain steps of the process or the implementation of scenarios involving specific situations (e.g. incidents, accidents, start-up, shut-down).

The monitoring module 42 is suitable for recording, as a function of time, the positions and orientations from the viewpoint of the operator 36 or of the robot 38 in the immersive three-dimensional representation 12, the input data received by the module 30 for dynamic simulation of the process, including the controls performed by means of the simulated controls 34A to 34C, and the process parameters obtained by means of the module 30 for dynamic simulation of the process. Same is also suitable for recording and time-stamping pictures and/or videos of the viewpoint observed over time by the operator 36 or the robot 38.

The positions include e.g. a latitude, a longitude, and an altitude. The orientations include e.g. an orientation angle of a central axis from the viewpoint of the operator 36 or of the robot 38, in particular an upward or a downward inclination angle, or an angle of lateral pivoting to the left or to the right of the head thereof.

The monitoring module 42 further includes a speech recognition application 70, suitable for recording the words pronounced by the operator 36 and for automatically transcribing the words in the form of a text into a computer file, by time-stamping the words.

Thereby, the monitoring module 42 is apt to generate and feed a computer base 72 of monitoring data as a function of time.

The monitoring data comprise at least the positions and orientations of the operator or of the robot 38 in the immersive three-dimensional representation of the facility 12, the actions performed by the operator in such environment, e.g. the controls applied to the simulated controls 34A to 34C, the statements of the operator 36 when same implements actions, pictures and/or videos from the viewpoint of the operator or of the robot 38, and process parameters of the facility, resulting from the actions the operator.

In the example shown in FIG. 1, the rendering module 44 is suitable for collecting monitoring data recorded in the database of monitoring data 72, and for processing the monitoring data for extracting therefrom, a rendering of a virtual implementation of the process intended for the conduct or the optimization of the process.

In the first example shown in FIG. 1, the rendering module 44 comprises an application 74 for automatically generating an operating procedure, apt to select and aggregate monitoring data obtained from the monitoring database 72, so as to automatically generate a report 78 on the implementation of the process, in the form of a computer file.

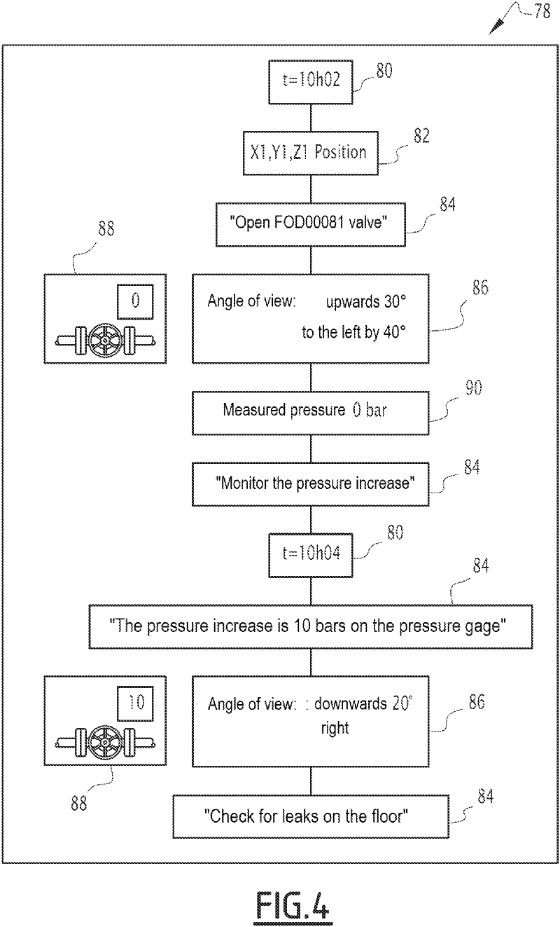

In the example shown in FIG. 4, the report 78 successively comprises a rendering of the time at which an event occurred (label 80), a position of the operator 36 at the given time (label 82), a rendering in text format of the declarations made by the operator 36 at the given time (label 84), a description of the angles of orientation of the viewpoint of the operator 36 (label 86) with the angle of inclination upwards or downwards and the angle of pivoting to the left or to the right, pictures or videos from the viewpoint of the operator 36 in the immersive three-dimensional representation 12 (label 88), parameter values of the process (label 90).

The rendering module 44 further includes a human-machine interface 96, e.g. a screen, a keyboard and/or a mouse allowing the operator 36 to modify the report on the implementation of the process, in order to delete, add or modify actions recorded in the report on the implementation of the process, and thereby finalize an operational implementation procedure from the rendering obtained using the rendering module 44.

A first example of a method of virtual implementation of an industrial process in an industrial facility 12, by means of a virtual evaluation system 10, will now be described.

In the present example, the implementation aims at the automatic generation of an operational procedure intended for being provided to process operators in the real facility. The operational procedure is intended for documenting an industrial process to be implemented in the facility.

Initially, an operator is provided with a list of actions to be performed for the implementation of the industrial process in the facility.

The operator 36 is then equipped with the display and/or control system 34. E.g., the operator puts on a virtual reality headset 64 and takes hold of the control lever 66.

Advantageously, another operator 332 accesses the control interface 22 of the process simulation module 30, for monitoring the implementation of the process by the operator 36.

The operator 36 is then placed at an initial position with an initial viewpoint.

The immersive simulation module 32 then generates the associated immersive three-dimensional representation 12 from the digital mock-up and the rendering set 59 provides the operator 36 with an immersive view from the position thereof and with the viewpoint thereof in the immersive three-dimensional representation 12. The three-dimensional immersive representation corresponds to the view that the operator 36 would have in the real facility, at the same point and with the same viewpoint.

The immersive simulation module 32 advantageously calculates the constraints applying to the operator 36, possibly limiting the movements thereof or the consequences of the actions thereof on the environment, during the implementation of the process.

As illustrated in FIG. 2, the operator 36 sees in the viewpoint thereof, the arrangement of the infrastructures 14 of the facility, of the equipment 16, and, if appropriate, of the available controls 18 with which the simulated controls 34A to 34C are associated. The operator also has a display of the sensors 20.

By acting on the joystick 62, the operator 36 moves into the immersive three-dimensional representation 12 of the facility, which modifies the operator’s position. The operator can turn his/her head, or change the position of his/her limbs, so as to observe the equipment 16 from another viewpoint, or to actuate the simulated controls 34A to 34C.

Simultaneously, the module 30 for dynamic simulation of the process reads the input parameters collected by the centralization and interface module 40 from the immersive simulation module 32 and simulates the physical parameters of the process implemented in the facility.

The physical parameters are sent back to the centralization and interface module 40, then are read by the immersive simulation module 32 for being displayed, e.g. at the representation of a sensor 20.

The operator 36 then implements a first action of the process. E.g., the first action consists in moving in the immersive three-dimensional representation 12 to a given point facing a control 18, and in actuating the corresponding simulated control 34A. The above corresponds e.g. to a real action, such as opening a valve.

The monitoring module 42 records at all times, the position of the operator 36, the orientation of the operator’s viewpoint, more particularly the vertical and horizontal orientation of the viewpoint thereof.

Using the speech recognition application 70, the monitoring module 42 records the statements of the operator 36 in text form.

The monitoring module 42 further records the process parameters determined by the module 30 for dynamic simulation of the process, at the same instant.

E.g., in the example shown in FIG. 4, at the instant 10:02, the operator 36 is at a position X1, Y1, Z1 in front of the valve FOD0081. Said position is recorded by the monitoring module 42.

The operator 36 declares that he/she will “open the valve FOD0081”, which is transcribed in text form by the speech recognition application 70 and saved by the monitoring module 42.

Furthermore, the operator 36 moves his/her head to observe the pressure measured by the sensor, and declares “monitor the pressure increase”, which is recorded in a text form by the speech recognition application 70 and saved by the monitoring module 42.

The monitoring module 42 records a picture and/or a video from the viewpoint of the operator, in the immersive three-dimensional representation 12.

The angle of view of the operator is directed upwards by 30° and to the left by 40°. The pressure measured in the equipment downstream of the valve is 0 bar. The orientation values are saved by the monitoring module 42.

Then, at the next instant, corresponding to 10:04, the operator 36 continues the implementation of the list of actions to be performed in the immersive three-dimensional representation 12.

At each action performed, the immersive simulation module 32 computes input parameters resulting from the actions of the operator (whether or not voluntary), advantageously using physical impact models of the aforementioned actions. The input parameters are sent to the centralization and interface module 40.

The module 30 for dynamic simulation of the process then simulates the evolution over time of the operating parameters of the process as a function of the input parameters defined by the actions of the operator in the immersive simulation module 32, by obtaining same in the centralization and interface module 40.

Thereby, the module 30 for dynamic simulation of the process simulates the pressure increase observed following the opening of the valve controlled by the operator 36, allowing same to be displayed in the immersive three-dimensional representation 12 at the sensor 12. Furthermore, the operating parameters of the process are also recorded by the monitoring module 42.

A monitoring database 72 of the process is thus generated, including time data, position data of the operator 36 in the facility 12, orientation data of the operator 36 in the facility, more particularly orientation data from the viewpoint of the operator 36, pictures and/or videos from the viewpoint of the operator 36, transcriptions in the text form of statements of the operator 36 obtained by the speech recognition application 70 and operating parameters of the process elaborated by the module 30 for dynamic simulation of the process and/or simulation data elaborated by the immersive simulation module 32.

Once a virtual implementation of the process is complete, the rendering module 44 establishes a monitoring report 78 on the implementation of the process, transcribing, monitoring data as a function of time into a computer file.

Advantageously, the rendering module 44 is apt to filter monitoring data so as to exclude at least a portion thereof. Same is also apt to calculate other monitoring data from the monitoring data collected by the monitoring module 42.

A user can then use the human-machine interface 96 so as to modify and/or complete the report and finalize the operating procedure automatically generated by the system 10.

The virtual evaluation system 10 is thus easily implemented for quickly establishing an operating procedure of the process in a virtual environment. Since the operator 36 performs the steps of the procedure in the immersive three-dimensional representation 12, the operator has a realistic perception of the actions to be performed, with a response from the facility which corresponds to the response which would be observed in a real facility, since operating data are continuously simulated during a virtual implementation of the process.

The above is done cost effectively, without having to modify the real facility, nor having to affect production, or even while the real facility is not yet built. Moreover, the automatically generated operating procedure can be retested using a virtual evaluation system 10, without any risk of injury, damage or accident within the facility.

It is also possible to test a modification to the procedure before the modification is implemented, so as to check that the modification is suitable. Finally, a virtual evaluation system 10 is particularly effective in testing the start-up of a facility, determining the optimal start-up sequence, which reduces the start-up time.

In any case, a virtual evaluation system 10 provides a safe solution which consumes very little time and resources for generating, modifying and testing operating procedures before starting up a facility, or during a more established operation. The investment is minimal, and the risk is reduced in the event of a problematic step.

The virtual evaluation system 10 automatically generates a report in the form of a clear and structured computer file which serves as a basis for writing the operating procedure.

When the procedure is completed, same can be produced in the form of a computer file, which can be printed or displayed, or in the form of a video file illustrating all the actions to be performed during the procedure. The fact that the procedure is delivered both as a text file and as a video makes it easier for the operator 36 to understand.

The above is particularly useful compared to procedures written manually in the traditional way, which are not tested before the first implementation thereof.

A variant of a virtual evaluation system 10 according to the invention is illustrated by FIG. 5. Unlike the system 10 shown in FIG. 1, the display and/or control system 34 is suitable for being connected to a robot 38, more particularly to a control unit 100 of the robot 38.

Thereby, the robot 38 is suitable for operating in the immersive three-dimensional representation 12, in order to move, and, if appropriate, to actuate controls, so as to virtually reproduce the steps of the process.

In parallel, an operator 39, e.g. a driver 39 of the robot, is also able connect to the display and/or control system 34, in particular to display the movement of the robot 38, adopting the same viewpoint as the robot 38.

In such variant, the initialization module 46 is suitable for making possible the programming of the control unit 100 of the robot, so that the robot 38 carries out all the expected steps of the process.

Thereby, the robot 38 is apt to move in the immersive three-dimensional representation of the facility 12, using a virtual immersion module 32, and to actuate the simulated controls 34A to 34C, as described above for the operator 36.

The immersive simulation module 32 dynamically computes sensor data from monitoring the movement of the robot 38, during a virtual implementation of the process according to a physical model of movement of the robot in the facility and sends the monitoring sensor data to the control unit 100 of the robot 38.

The module 30 for dynamic simulation of the process, simulates in real time, the operating parameters of the facility, on the basis of the actions performed by the robot 38.

The above allows the robot 38 to be trained before the robot is deployed in the real facility, so as to optimize the robot’s operation within the real facility.

In an advantageous variant, which applies to a virtual movement of the robot 38 in the immersive three-dimensional representation 12, but also to a real movement of the robot in the real facility, the control unit 100 of the robot 38 is apt to block the movement of the robot 38 if operating conditions of the process are not compatible with the movement of the robot 38.

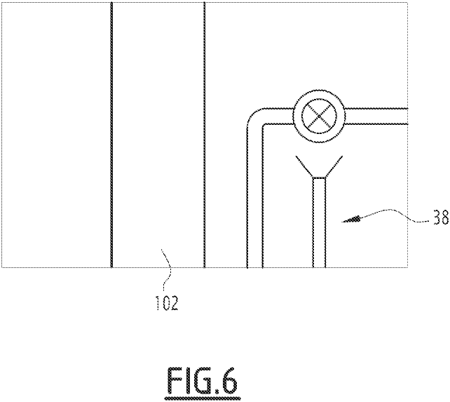

Such might be the case e.g. if the robot 38 meets an obstacle 102, as illustrated in FIG. 6. The driver 39 of the robot 38 or an artificial intelligence engine associated with the control unit 100 of the robot 38, is then apt to propose a modification of the process and to activate a virtual evaluation system 10 in order to virtually continue the implementation of the modified process, in the immersive three-dimensional representation 12, in order to determine whether the modifications of the process lead to operating conditions of the process which authorize the further implementation of the process.

E.g. the driver 39 or the artificial intelligence engine is suitable for proposing a modification of the movement of the robot 38, if the robot meets an obstacle 102 and the rendering module 44 is suitable for identifying that the movement of the robot 38 is possible, unlocking the operation of the robot 38.

In a variant, if the robot 38 has to perform an intervention in a real facility, which modifies the operating parameters of the process, the modification can be implemented virtually beforehand, in the immersive three-dimensional representation 12, using the virtual evaluation system 10. The rendering module 44 is advantageously suitable for determining, on the basis of monitoring data including e.g. physical operating parameters of the process obtained using the module 30 for dynamic simulation of the process, and advantageously on the basis of data from sensors monitoring the robot 38 obtained by the immersive simulation module 32, whether predefined operating conditions of the process are fulfilled for authorizing the intervention, or if the conditions are not fulfilled.

Advantageously, the rendering module 44 is suitable for automatically authorizing the continuation of the process, on the basis of conditions determined from a computation, or from a database of operating conditions.

In all the preceding cases, the driver 39 of the robot 38 can use the display and/or control system 34 for monitoring the path of the robot 38 in the immersive three-dimensional representation 12, during the implementation of a virtual process or after the implementation.

The above allows the driver to quickly and precisely to become aware of the situation of the robot 38 which caused the blockage.

The virtual implementation advantageously determines whether the abilities of the robot 38 remain satisfactory for carrying out the operation. E.g., the immersive simulation module 32 determines whether the robot 38 has enough energy to continue the operations thereof, or whether the robot is positioned correctly for performing the operations requested therefrom or any other physical parameter of the operation of the robot 38.

In the case, where an artificial intelligence engine is used for determining modifications to the implemented process, a virtual evaluation system 10 can quickly and easily test a plurality of modifications and thus determine whether a quick and simple solution can exist and can be automated, before the driver 39 is made aware of the blocking of the robot 38.

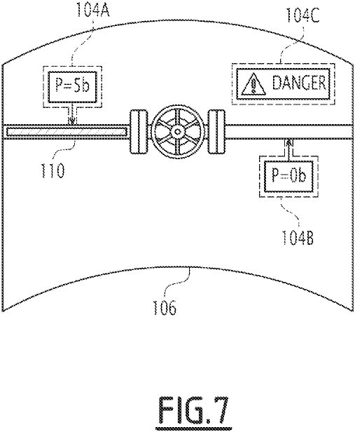

In another variant, illustrated by FIG. 7, the immersive simulation module 32 is apt to add to the immersive three-dimensional representation 12 at least one piece of information relating to the process intended for the operator 36, coming from the module 30 for dynamic simulation of the process. Advantageously, the immersive simulation module 32 is suitable for representing, in the immersive three-dimensional representation, a monitoring tool 106 of the process on which is displayed the or each piece of information relating to the process 104A to 104C, 110, the monitoring tool 106 being more particularly an augmented reality device intended for being worn by the operator 36 in the real facility.

The display of the monitoring tool 104 in the immersive three-dimensional representation 12, simulates the use by an operator 36 of the tool 104, even though the tool 104 is not yet developed or finalized, or further for modifying information 104A to 104C, 110 presented by an existing tool 104.

The augmented reality device comprises e.g. augmented reality glasses, or a tablet displaying a view of the facility and the superimposed information 104A to 104C, 110.

During a virtual implementation of the process, the immersive simulation module 32 loads, from the centralization and interface module 40, operating data of the process determined in real time by the module 30 for dynamic simulation of the process. The information 104A to 104B is e.g. operating data received from the module 30 for dynamic simulation of the process and/or data calculated from the operating data.

In the example illustrated in FIG. 7, the information 104A to 104C, 110 is displayed as a superposition on the infrastructures 14, the equipment 16 or the controls 18, e.g. to indicate the value of a physical parameter of an item of equipment 16 (the information 104A and 104B are here pressures measured upstream and downstream of a valve), to indicate the presence of a hazard (information 104C), or to characterize a flow flowing through an item of equipment, e.g. by a color marking 110 as a function of temperature or pressure.

The information 104A to 104C, 110 is surrounded by a dotted line in FIG. 7.

Thus, the operator 38 is apt to virtually implement the process in the immersive three-dimensional representation 12, while having a simulation of the information 104A to 104C, 110 that the operator would have available if the operator were equipped in the real facility with a real tool 104, e.g. an augmented reality device.

As before, the rendering module 44 is suitable for recording the position, the viewpoint and the statements of the operator 36, and the corresponding process parameters, so as to determine whether the displayed indications are relevant and useful for the conduct of the process.

In such respect, the initialization module 46 can be programmed for testing the displayed information and the possible tools 104 in a plurality of operating frames during the design of the tool 104 which is intended to be supplied to the operators.

It is thus possible to modify the information displayed, or the arrangement thereof in the tool 106, depending on the potential situations encountered or the changes of situation. The above minimizes the costs of developing and testing such tools 106, optimizing the interest thereof for the operators 36.

Thanks to a virtual evaluation system 10 according to the invention, it is thus possible to easily develop operating procedures, to train robots, or yet to design tools and information applications for the operators of an industrial process, reducing the risks associated with such developments, and the adverse situations which might occur, if such elements were tested in a real facility.

The virtual evaluation system 10, through the connection between a virtual immersion module 32 and the process simulation module 30 by means of the centralization and interface module 40 and through the presence of a module for monitoring the implementation 42 and of a rendering module 44, is particularly useful for obtaining an immersive three-dimensional representation 12 as close as possible to the real environment, while having a precise and directly usable rendering of a virtual implementation of the process.

The above increases the safety of industrial facilities, reduces the development and start-up cost of the facilities, and makes it possible to test design or modification solutions, cost effectively and without any risk.

As indicated hereinabove, the virtual evaluation method implemented using the system 10 is particularly advantageous for obtaining an operating procedure for conducting a real process in an industrial facility.

The virtual execution method as defined hereinabove is implemented a plurality of times by the operator, starting from a list of goals to be achieved and/or actions to be carried out, varying the execution conditions of the actions to be performed, e.g. the order of the actions performed, the control parameters of the process when performing the actions, including causing malfunctions of equipment affecting the process, the movements made to perform the actions, or by measuring the adequacy between the manipulations by the operator and the response time of the process.

The operator does not reproduce a predefined operating mode, or a precise script like within the framework of a virtual training but has a margin of maneuver for testing different execution conditions and different operating paths in order to achieve the goals, without prejudging the result which will be achieved.

At each implementation, the rendering module 44 produces a report of virtual implementation of the process, as defined above, on the basis of the monitoring data collected by the monitoring module 42.

The rendering module 44 carries out at least one processing of the monitoring data such as:
Definition of technical information relevant to the context. The above includes:
   the state variables internal to the process including the physical-chemical states of the matter (multiphase state of the fluid)
   the amount of energy consumption and emissions to the atmosphere
   the contribution to the overall efficiency of the facility
Filtering of collected data through sampling criteria, which includes, but is not limited to:
   Sampling rate of the instrumentation
   Amplitude of movements of recorded actuators
   Viewing positions

A user can then filter the consolidated data in the report by determining:
Accuracy of results
Nature of the information retained for each step of the procedure
Generation of curves and other key performance indicators

The rendering module 44 is also apt to automatically establishing the performance of the procedure by computing objective criteria evaluating the elements defined hereinabove.

Such computation advantageously takes the form of a weighted sum of the criteria including at least the obtaining of the desired final state, the time required to obtain the final state, compliance with the alarm thresholds of the process and compliance with the operating limits of the facility such as the pressure limits. It is also possible to add criteria related to emissions of greenhouse gases or other pollutants or criteria aimed at minimizing the cost of the operation, depending on the relevance to the operation being evaluated.

Thus, a plurality of reports on virtual implementations of the process are obtained through a plurality of implementations of the virtual execution process as defined hereinabove, under different execution conditions of the virtual execution process.

It is in this way possible to test quickly, safely, and cost effectively, the impact of different execution conditions on the parameters of the process as computed by the module for dynamic simulation 30 and more generally on the operation of the real process in the industrial facility.

The procedure of the process is then prepared using one of the reports on a virtual implementation of the process. Same is subsequently used for operating a real industrial process in an industrial facility according to the procedure.

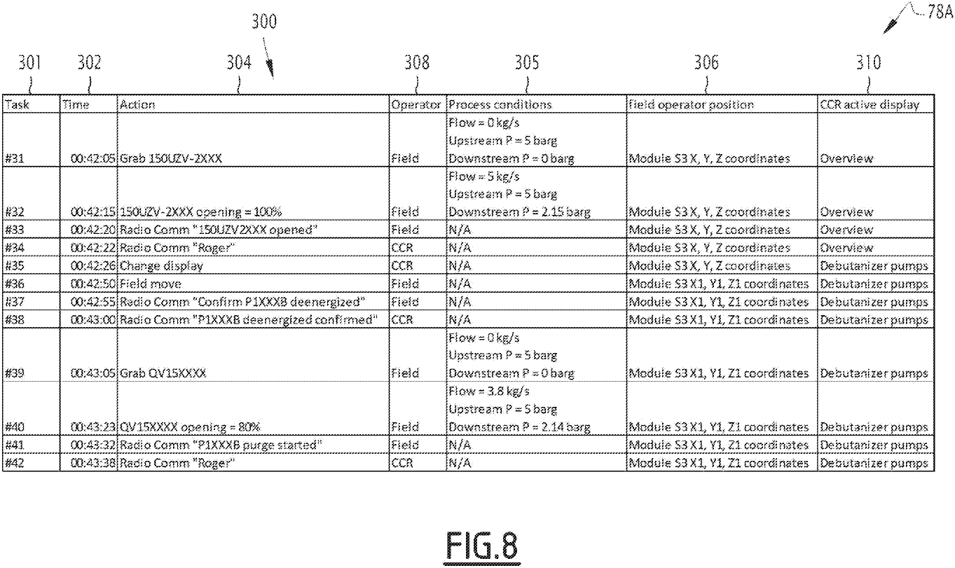

FIG. 8 illustrates another example of a report 78A on the implementation of the process, as obtained by a virtual evaluation method according to the invention. The 78A report is generated in English, which is the usual language of procedure manuals.

The report on the implementation of the process 78A includes a table 300 listing a list 301 of action numbers, a list 302 of execution times of actions performed in the immersive three-dimensional representation, a corresponding list 304 of actions performed in the immersive three-dimensional representation, corresponding to each time in the list 302, the actions performed being advantageously obtained using controls applied to the simulated controls, and/or statements of the operator when the operator implements actions, and/or pictures and/or videos from the viewpoint of the operator or of the robot.

The table 300 further includes a corresponding list 305 of values of parameters of the process, as obtained using the module 30 for dynamic simulation, a corresponding list 306 of positions of the operator or of the robot and/or of orientations from the viewpoint of the operator or of the robot, corresponding to each time of the list 302.

Advantageously, the table 300 further includes a corresponding list 308 of identifiers of the operator implementing an action corresponding to each time of the list 302.

Said list is useful in particular when the system 10 includes a control room simulation module interconnected to the module 30 for dynamic simulation of the process and to the immersive simulation module 32, via the centralization or interface module 40, for enabling a control operator to monitor, on at least one display window of the process, the operating parameters of the process resulting from the actions performed in the immersive three-dimensional representation 12.

In such case, the monitoring data recorded by the monitoring module 42 include an identifier of the operator performing an action, declarations of the control operator and/or an identifier of the display window of the process, activated by the control operator.

Advantageously, the table 300 then includes a corresponding list 310 of identifiers of the display window of the process, corresponding to each time of the list 302.

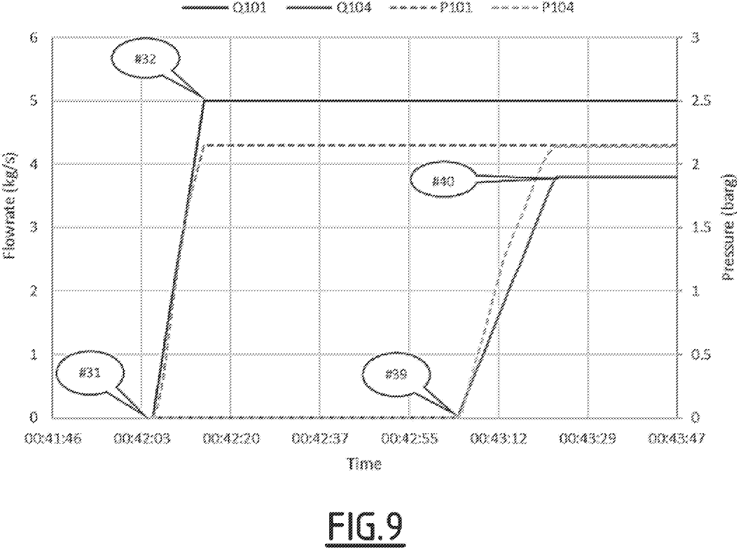

The report 78A comprises, if appropriate, in addition to the table 300, one or a plurality of graphs (an example of which is illustrated in FIG. 9) illustrating in particular, physical parameters simulated by the module 30 for dynamic simulation of the process (e.g. the flow rate through a valve, in solid line in FIG. 9 and the pressure downstream of the valve, in dotted line in FIG. 9) during the implementation of the virtual execution method according to the invention

The table 300, if appropriate with one or a plurality of graphs, can then be used as a process of operation during the real conduct of the process. For this purpose, same is edited by a technical field expert and validated after the procedure is re-executed by peers. Same is also compared with other reports of the same operation on the basis of objective criteria generated by the rendering module 44.

1. A: industrial process virtual evaluation system the industrial process being intended to be implemented in an industrial facility, the industrial process virtual evaluation system comprising
at least one computer platform configured to :
dynamically compute in a dynamic process simulator operating parameters of the industral process, based on input parameters;
generate in an imersive simulator an immersive three-dimensional of the indurstal facility comprising a plurality of simulated controls confugured to define the input parameters;
a display and/or controller configured to be operated by a real operator and/or by a robot, to navigate in the immersive three-dimensional representaion, and to actuain al least one of the plurality of simulated control;
the at least one computer platform being cofigured to;
interconnect in an interface the dynamic computering of operating parameters of the industral process and the generating of the an imumersive three-dimensional respensention of the industral facility so as to allow the operator and/or the robot to perform in real time, in the immersive three-dimensional representation a virtual implementation of the industrial process comprising actions performed in the immersive three-dimensional representation, the actions performed in the immersive three-dimensional represention including the actuation of the at least one simulated control,
receive from the dynamic computing of operating paramerters of the industral process, operating parameters of the industrial process as a function of the input parameters, resulting from the actions performed by the operator and/or the robot in the immersive three-dimensional representaion;
record monitoring data including operating parameters of the process and/or actions of the operator and/or of the robot as a function of time;
process the monitoring data and provide a rendering of a virtual implementation of the industral process, to conduct or optimize the industrial process.

2. The virtual evaluation system according to claim 1, wherein the interface is configured to
dynamically receive at least one input parameter of the imput paramters resulting from a simulated control performed by the operator and/or the robot in the immersive three-dimensional representation generated by the immersive simulator the dynamic process simulator being configured to load the at least one input parameter received in the interface, so as to perform a dynamic simulation of the process, and to obtain at least one operating parameter of the process, on the basis of the at least one input parameter resulting from a simulated control performed by the operator and/or the robot in the immersive three-dimensional representation the interface being configured to dynamically receive the at least one operating parameter of the process resulting from the dynamic simulation of the process.

3. The virtual evaluation system according to claim 1, wherein the at least one computer platform in configured to automatically produce a report on a virtual implementation of the process, including a time-dependent list of the monitoring data.

4. The virtual evaluation system according to claim 3, wherein the at least one computer platform includes a speech recognition application, the report on a virtual implementation of the process including a time-dependent word-by-word rendering of words pronounced by the operator during a virtual implementation of the process, as obtained using the speech recognition application.

5. The virtual evaluation system according to claim 3, wherein the display and/or controller comprises
sensor measuring positions and orientations of the operator and/or of the robot in the immersive three-dimensional the report on a virtual implementation of the process comprising a list of orientation position data from a viewpoint of the operator and/or of the robot as a function of in the immersive three-dimensional representation during a virtual implementation of the process, the viewpoint of the operator and/or of the robot being obtained from measurements taken by the sensor measuring position and orentation of the operator and/or of the robot in the immersive three-dimensional representaion.

6. The virtual evaluntion system according to claim 3, wherein the report on a virtual implementation of the process includes a list of pictures or videos from a viewpoint of the operator, as a function of time, in the immersive three-dimensional representation during a virtual implementation of the process.

7. The virtual evaluation system according to claim 3, wherein the report on a virtual implementation of the process comprises recorded values of the operating parameters of the process.

8. The virtual evaluntion system according to claim 3, wherein the display and/or controller is configured to be operated by a robot comprising a robot controller containing a list of actions of a real or a virtual process to be carried out, the robot being configured, during the implementing of the real or a virtual process, to stop the actions to be carried out in the presence of conditions temporarily preventing the continuation of the real or a virtual implementation of the process, the robot or a driver of the robot being configured to initiate a virtual implementation of a continuation of the process, on the basis of at least one modified action in the action list, the at least one computer platform being configured to establish, from the recorded monitoring data during a virtual implementation of the continuation of the process, evaluation criteria for an actual or virtual continuation of the process containing at least one modified action.

9. The vitural evulation system according to claim 1, wherein the immersive simulator configured to represent, in the immersive three-dimensional representation, at least one information relating to the process and intended for the operator, coming from the dynamic process simulator.

10. The virtual ecaluation system according to claim 9, wherein the immereive simulator is configured to represent, in the immersive three-dimensional representaion, a process monitoring tool displaying the process information.

11. A method of virtual execution of an industrial process, the industrial process being intended to be implemented in an industrial facility, the method comprising:
providing a virtual evaluation system according to claim 1;
navigation, via the display and/or controller of a real operator and/or of a robot in the immersive three-dimensional representation generated by the immersive simulator, so as to perform actions in the immersive three-dimmaional representation the actions including the actuation of at least one simulated control defining input parameters for the dynamic process simulator;
obtaining real-time operating parameters of the process, via the dynamic process simulator according to the input parameters resulting from the actions performed by the real operator and/or the robot, received by the interface and loaded by the dynamic process simulator;
recording, of monitoring data including operating parameters of the process and/or actions of the operator and/or of the robot as a function of time;
processing of the monitoring data obtained for providing a rendering of a virtual implementation of the process, intended for the conduct or the optimization of the industrial process.

12. The method according to claim 11, wherein the processing of the monitoring data comprises the automatic production of a report on a virtual implementation of the process, including a time-dependent list of monitoring data collected by the monitoring module (42).

13. The method according to claim 12, wherein the at least one computer platform includes a speech recognition application producing a word-by-word rendering of words pronounced by the operator during a virtual implementation of the process, the report on a virtual implementation of the process including the word-by-word rendering as a function of time.

14. The method according to claim 11, wherein the navigation comprises the operation of the display and/or controller by a robot, the robot comprising a central controller containing a list of actions of a real or a virtual process to be performed.

15. The method according to claim 14, wherein during the implementation of the real or a virtual process, the robot stops the actions the robot has to perform in the presence of conditions temporarily preventing the continuation of the real or a virtual implementation of the process, the method comprising the launch, by the robot or by a driver of the robot, of a virtual implementation of a continuation of the process, on the basis of at least one modified action in the action list, and establishing, from the monitoring data collected during a virtual implementation of the continuation of the process, evaluation criteria for a real or a virtual continuation of the process, containing at least one modified action.

16. The method according to claim 11, wherein the immersive simulator represents, in the immersive three-dimensional representation, a process monitoring tool, displaying information on the process to the operator .

17. A method comprising an implementation of the virtual execution method according to claim 12, to prepare a procedure from at least one virtual implementation of an industrial process, and operating a real industrial process in an industrial facility according to the procedure.

18. The method according to claim 17, wherein a plurality of reports on virtual implementations of the process are obtained by a plurality of implementations of the virtual execution method, under different execution conditions of the virtual execution method, the procedure being prepared using one of the plurality of reports on a virtual implementation of the process.

19. The system according to claim 2, wherein the immersive simulator is configured to load the at least one operating parameter of the process resulting from the dynamic simulation of the process, and to modify the immersive three-dimensional representation in response to the at least one operating parameter of the process resulting from the dynamic simulation of the process.
